(19) United States
(12) Patent Application Publication
(10) Pub. No.: US 2019/0144619 A1
(43) Pub. Date: May 16, 2019

(54) METHOD OF MANUFACTURING CORE MATERIAL AND METHOD OF MANUFACTURING COPPER CLAD LAMINATE

(71) Applicant: DISCO CORPORATION, Tokyo (JP)

(72) Inventor: Katsuhiko SUZUKI, Tokyo (JP)

(21) Appl. No.: 16/189,478

(22) Filed: Nov. 13, 2018

(30) Foreign Application Priority Data
Nov. 16, 2017 (JP) 2017-220965

(51) Int. Cl. C08J 5/24; B29C 67/00

(52) U.S. Cl. CPC C08J 5/24; B32B 15/092; B29C 67/0025

(57) ABSTRACT

A core material is formed by a core material preparing step of preparing the core material formed by impregnating a glass cloth with a synthetic resin, followed by drying, and a core material planarizing step of planarizing both sides of the core material by grinding. Copper foils are disposed on both sides of the planarized core material thus manufactured, and the resulting assembly is pressed from the both sides with heating, whereby a copper clad laminate of which both sides are planar can be formed.

### BACKGROUND OF THE INVENTION

### Field of the Invention

The present invention relates to a method of manufacturing a planarized core material for use in manufacture of a copper clad laminate and to a method of manufacturing a copper clad laminate using the planarized core material.

### Description of the Related Art

Device chips for use in electronic devices such as mobile phones and personal computers are bonded onto a printed board, and are finally incorporated in the electronic devices. For the printed board, a copper clad laminate is widely used. The copper clad laminate is manufactured, for example, by the following method. First, a glass cloth is prepared, then the glass cloth is impregnated with a synthetic resin (varnish), and the glass cloth is dried. Next, the glass cloth is cut to a predetermined size. Each of the pieces formed by thus cutting to the predetermined size becomes a core material called prepreg. Copper foils are laid on both sides of the core material (prepreg), and the resulting assembly is pressed from the both sides with heating, whereby the copper clad laminate is formed. Note that a plurality of core materials (prepregs) may be laminated and copper foils are disposed on both sides of the core materials, to form the copper clad laminate. Then, a wiring layer or layers may be formed on one or both of the sides of the thus formed copper clad laminate based on a copper foil or foils, whereby a printed board to be a mounting substrate for device chips can be formed (see Japanese Patent Laid-open No. 1981-118853 and Japanese Patent Laid-open No. 1984-39546).

In recent years, a mounting technology called flip chip bonding has been put to practical use, for space saving in regard of the region required for mounting, in mounting device chips onto a printed board. In the flip chip bonding, a plurality of metallic projections called bump having a height of approximately 10 to 100 μm are formed on the front side of each device, and the bumps are made to face electrodes formed on the printed board, and are bonded directly to the electrodes. In other words, the bumps function as terminals of the device chip.

### SUMMARY OF THE INVENTION

The glass cloth serving as a material for the core material is formed by weaving glass fibers. On the front side and the back side of the core material formed by the above-mentioned method, there is ruggedness (minute projections and recesses) due to the shape of the glass fibers and the weaving of the glass fibers. Therefore, the front side and the back side of the copper clad laminate manufactured by the above-described method are also rugged in shape. When the device chips are bonded onto the printed board formed from the copper clad laminate, the presence of the rugged shape on the mounting surface may cause a problem that the terminals of the device chips cannot be bonded appropriately. Such a problem is called defective bonding.

It is therefore an object of the present invention to provide a method of manufacturing a planarized core material usable for manufacture of a copper clad laminate by which defecting bonding of device chips can be restrained, and a method of manufacturing a copper clad laminate using the planarized core material.

In accordance with an aspect of the present invention, there is provided a method of manufacturing a planarized core material, the method including: a core material preparing step of preparing a core material formed by impregnating a glass cloth with a synthetic resin, followed by drying; and a core material planarizing step of planarizing both sides of the core material by grinding.

In accordance with another aspect of the present invention, there is provided a method of manufacturing a copper clad laminate, the method including: a core material preparing step of preparing a core material formed by impregnating a glass cloth with a synthetic resin, followed by drying; a core material planarizing step of planarizing both sides of the core material by grinding; and a copper clad laminate forming step of disposing copper foils on both sides of the core material planarized in the core material planarizing step, and pressing the resulting assembly from the both sides with heating, to form the copper clad laminate.

According to the described aspect of the present invention, both sides of the core material formed by impregnating the glass cloth with the synthetic resin, followed by drying, are ground to planarize the both sides of the core material. Therefore, for example, when copper foils are disposed on both sides of the core material having been planarized and the resulting assembly is pressed from the both sides with heating to form a copper clad laminate, the front side and the back side of the copper clad laminate are also planar. When the copper clad laminate of which the front side and the back side are planar can be formed, device chips can be bonded onto the copper clad laminate while restraining generation of defective bonding.

Accordingly, the present invention provides a method of manufacturing a planarized core material usable for manufacture of a copper clad material by which defective bonding of device chips can be restrained, and a method of manufacturing a copper clad laminate using the planarized core material.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a figure depicting schematically formation of a core material;

FIG. 2 is a perspective view depicting schematically a grinding apparatus;

FIG. 3A is a sectional view depicting schematically a step of planarizing a first side of the core material;

FIG. 3B is a sectional view depicting schematically a step of planarizing a second side of the core material;

FIG. 4A is a side view depicting schematically the core material and copper foils;

FIG. 4B is a side view depicting schematically a copper clad laminate forming step; and

FIG. 4C is a perspective view depicting schematically a copper clad laminate.

### DETAILED DESCRIPTION OF THE PREFERRED EMBODIMENT

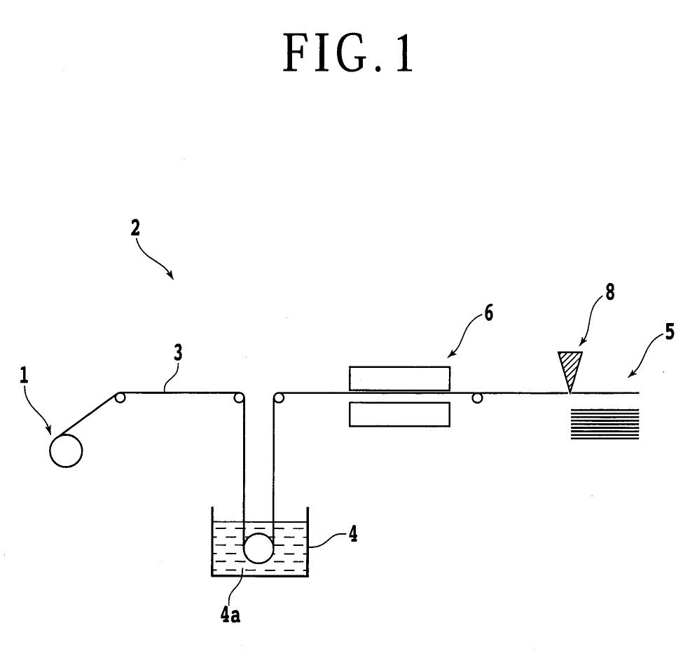

An embodiment of the present invention will be described referring to the attached drawings. First, formation of a core material (prepreg) planarized by a manufacturing method according to the present embodiment will be described referring to FIG. 1. FIG. 1 is a figure depicting schematically the formation of the core material.

A core material 5 is manufactured, for example, by use of a core material manufacturing apparatus 2 depicted in FIG. 1. The core material manufacturing apparatus 2 includes an impregnation vat 4 in which a liquid synthetic resin (varnish) is reserved, a heater 6, and a cutter 8. The core material 5 is formed from a glass cloth in which glass fibers are woven. A glass cloth roll 1 in which the glass cloth is rolled is disposed on the core material manufacturing apparatus 2, and a belt-shaped glass cloth 3 is pulled out from the glass cloth roll 1. Then, the glass cloth 3 is passed through a synthetic resin 4a in the impregnation vat 4, to impregnate the glass cloth 3 with the synthetic resin 4a. Note that the synthetic resin 4a is, for example, a resin such as an epoxy resin, a phenolic resin, or a polyether-ether ketone (PEEK) resin in an uncured state. Next, the glass cloth 3 impregnated with the synthetic resin 4a is passed through the heater 6. In the heater 6, the glass cloth 3 is heated and dried, to cure the synthetic resin 4a with which the glass cloth 3 is impregnated. Thereafter, the glass cloth 3 is cut to a predetermined size by the cutter 8. As a result, the core material 5 is formed. Note that the core material 5 may be a laminate of a plurality of the glass cloths 3.

Each of steps in a method of manufacturing a planarized core material according to the present embodiment will be described. In the method of manufacturing the planarized core material, a preparation step of preparing the core material 5 formed by impregnating the glass cloth with the synthetic resin, followed by drying is conducted. In the preparation step, the core material 5 manufactured by the above-mentioned method is prepared.

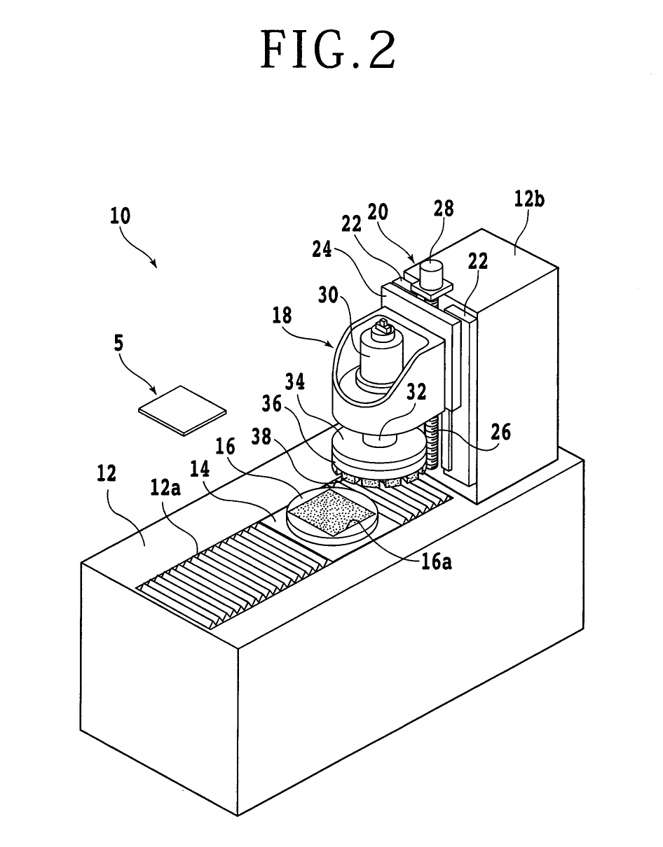

Next, in the manufacturing method according to the present embodiment, a core material planarizing step of planarizing both sides of the core material 5 by grinding is performed. The core material planarizing step is carried out, for example, by a grinding apparatus depicted in FIG. 2. FIG. 2 is a perspective view depicting schematically the grinding apparatus. A grinding apparatus 10 for use in the core material planarizing step has a base 12 adapted to support each of components. An upper surface of the base 12 is provided with an opening 12a. In the opening 12a is provided an X-axis moving table 14 having an upper surface on which a chuck table 16 adapted to hold the core material 5 by suction is mounted. The X-axis moving table 14 is movable in an X-axis direction by an X-axis direction moving mechanism (not depicted). An upper surface of the chuck table 16 constitutes a holding surface 16a on which to hold the core material 5. The chuck table 16 is provided therein with a suction passage of which one end communicates with the holding surface 16a of the chuck table 16 and the other end is connected to a suction source (not depicted). When the suction source is operated, a negative pressure acts on the core material 5 mounted on the holding surface 16a, whereby the core material 5 is suction held on the chuck table 16. In addition, the chuck table 16 can be rotated around an axis extending along the vertical direction with respect to the holding surface 16a.

On the upper side of the chuck table 16, a grinding unit 18 adapted to grind the core material 5 is disposed. A support section 12b is erected at an end portion on the rear side of the base 12 of the grinding apparatus 10, and the grinding unit 18 is supported by the support section 12b. The grinding unit 18 is movable in the vertical direction by a Z-axis moving mechanism 20 disposed on a front surface of the support section 12b. The Z-axis moving mechanism 20 includes a pair of Z-axis guide rails 22 extending in the Z-axis direction on the front surface of the support section 12b, and a Z-axis moving plate 24 slidably mounted to the Z-axis guide rails 22. A nut section (not depicted) is provided on a back side (rear surface side) of the Z-axis moving plate 24, and the nut section is in screw engagement with a Z-axis ball screw 26 parallel to the Z-axis guide rails 22. A Z-axis pulse motor 28 is connected to one end portion of the Z-axis ball screw 26. With the Z-axis ball screw 26 rotated by the Z-axis pulse motor 28, the Z-axis moving plate 24 is moved in the Z-axis direction along the Z-axis guide rails 22.

The grinding unit 18 is fixed at a lower portion on a front surface side of the Z-axis moving plate 24. With the Z-axis moving plate 24 moved in the Z-axis direction, the grinding unit 18 can be moved in the Z-axis direction. The grinding unit 18 includes a spindle 32 rotated by a motor (not depicted) connected to a base end side thereof, and a grinding wheel 36 fixed to a mount 34 disposed on a tip side of the spindle 32. The motor is provided inside a spindle housing 30, and, when the motor is operated, the grinding wheel 36 is rotated attendant on the rotation of the spindle 32.

Grindstones 38 are provided on a lower surface of the grinding wheel 36. When the spindle 32 is rotated to rotate the grinding wheel 36, and the grinding unit 18 is lowered along the Z-axis direction to bring the lower ends of the grindstones 38 into contact with the core material 5, the core material 5 is ground. When the grinding unit 18 is lowered to a predetermined height position, a ground surface of the core material 5 is planarized. The grindstones 38 are formed from a material prepared by dispersing abrasive grains in a binder. In the method of manufacturing the core material according to one mode of the present invention, preferably, the grindstones 38 of a grain size (#) of approximately 320 to 600 are used. If grindstones of too fine grain size are used, clogging or the like may be generated during grinding.

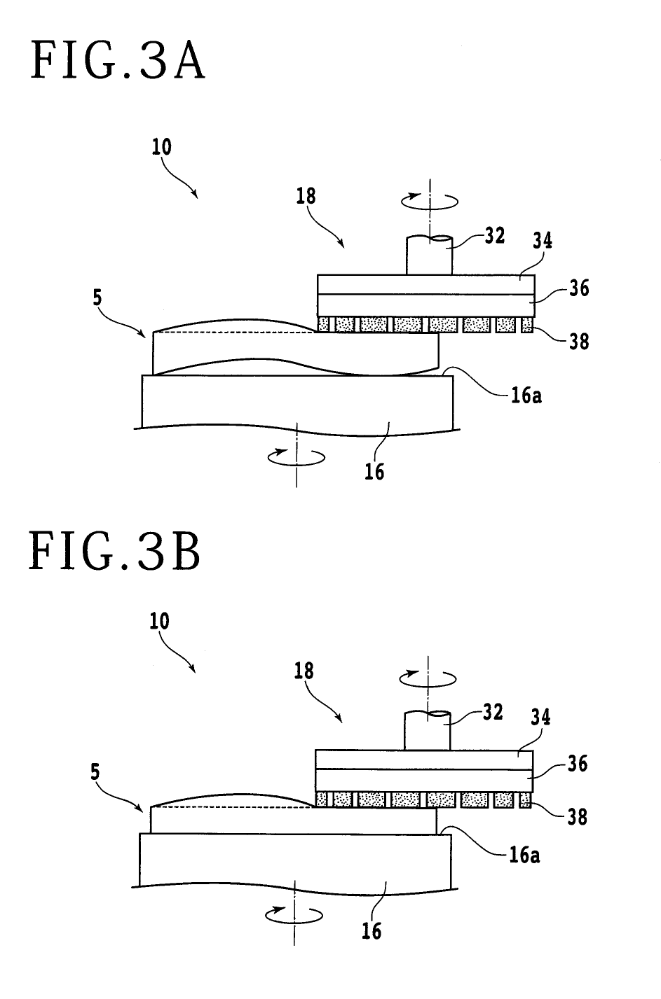

In the core material planarizing step, first, the core material 5 is placed on the holding surface 16a of the chuck table 16, and the suction source (not depicted) for the chuck table 16 is operated, whereby the core material 5 is suction held by the chuck table 16. Next, the X-axis moving table 14 is moved to a position under the grinding unit 18. Then, while rotating the chuck table 16 and the grinding wheel 36, the grinding wheel 36 is lowered. FIG. 3A is a sectional view depicting schematically a step of planarizing a first side of the core material 5. As depicted in FIG. 3A, when the grindstones 38 mounted to the grinding wheel 36 make contact with the first side of the core material 5, the first side is ground, and the first side is planarized.

After the grinding of the first side is completed, the X-axis moving table 14 is moved to bring the chuck table 16 out of the region under the grinding unit 18, and the suction holding by the chuck table 16 is released. Thereafter, the core material 5 is inverted upside down and placed on the holding surface 16a, and the core material 5 is again suction held by the chuck table 16. Then, the X-axis moving table 14 is moved to a position under the grinding unit 18, and, while the chuck table 16 and the grinding wheel 36 are rotated, the grinding wheel 36 is lowered. FIG. 3B is a sectional view depicting schematically the step of planarizing a second side of the core material 5. As illustrated in FIG. 3B, the second side of the core material 5 is ground and planarized, in the similar manner to the first side. After the grinding of the second side is completed, the X-axis moving table 14 is moved to bring the chuck table 16 out of the region under the grinding unit 18, and the suction holding by the chuck table 16 is released. As a result, the core material 5 having both sides planarized by grinding is obtained.

When the core material 5 having both sides planarized is used for forming a copper clad laminate, a copper clad laminate of which both sides are planar can be obtained. When a printed board is formed from the planar copper clad laminate, and device chips are bonded to the printed board, defective mounting is less liable to be generated. The core material 5 is formed in a thickness of, for example, approximately 400 to 800 μm, and each side thereof is ground by an amount of approximately 20 to 40 μm by the grinding. In other words, on each side of the core material 5, a thickness of approximately 5% of the thickness of the core material 5 is removed by the grinding, and the core material 5 is thinned to a thickness of approximately 90% of the thickness before grinding.

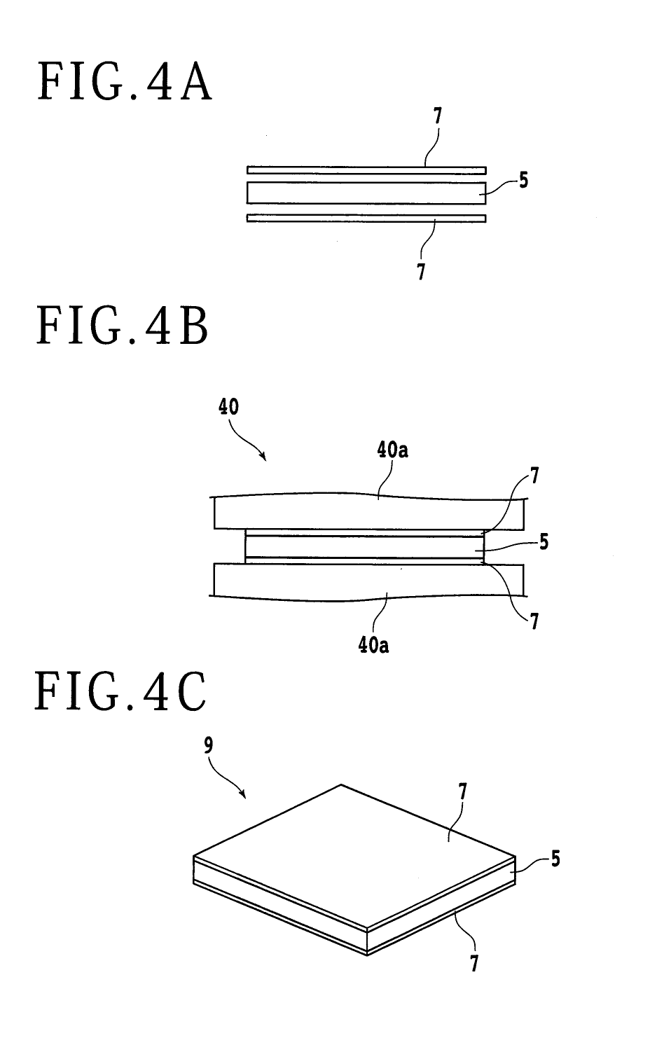

A method of forming the copper clad laminate of which the front side and the back side are planar will be described below. In the method of manufacturing the copper clad laminate, first, a planarized core material preparing step of preparing the planarized core material manufactured by the aforementioned method of manufacturing the planarized core material is performed. Next, a copper clad laminate forming step is conducted. In the copper clad laminate forming step, first, copper foils are disposed on both sides of the planarized core material 5. FIG. 4A is a side view depicting schematically the planarized core material and the copper foils. Copper foils 7 disposed on both sides of the core material 5 is formed in a flat surface shape in the similar manner to the core material 5.

Next, the core material 5 with the copper foils 7 disposed on both sides thereof is pressed from the both sides with heating. For the heating and pressing of the core material 5, there is used, for example, a heating and pressing apparatus 40 depicted in FIG. 4B. Here, FIG. 4B is a side view depicting schematically the copper clad laminate forming step. The heating and pressing apparatus 40 includes, for example, a pair of pressing plates 40a on the upper and lower sides, and has a function of moving the pair of pressing plates 40a toward each other. A heater is disposed in the inside of one or both of the pair of pressing plates 40a. At the time of pressing the core material 5 from both sides with heating, the core material 5 with the copper foils 7 disposed on both sides thereof is fed to a position between the pair of pressing plates 40a, and, while the heater is operated, the pair of pressing plates 40a are moved toward each other. As a result, the core material 5 is pressed while being heated, whereby the copper foils 7 are joined to the core material 5, and the copper clad laminate is formed.

The copper clad laminate thus formed is depicted in FIG. 4C. FIG. 4C is a perspective view depicting schematically the copper clad laminate. When the copper clad laminate forming step is conducted, a copper clad laminate 9 in which the coper foils 7 are joined to both sides of the core material 5 having been planarized is formed. In the present method of manufacturing the copper clad laminate, the copper clad laminate 9 is formed by use of the core material 5 having both sides planarized, and, therefore, both sides of the copper clad laminate 9 thus formed are also planar. This ensures that when device chips are bonded to the copper clad laminate 9, generation of defective bonding is restrained.

Note that the present invention is not limited to the description of the embodiment above, but can be carried out with various modifications. For example, while the copper foils 7 have been disposed on both planarized sides of the core material 5 to form the copper clad laminate 9 in the above-described embodiment, this is not limitative of the present invention. For instance, the copper foil 7 may be disposed on one planarized side of the core material 5 to form the copper clad laminate 9. In addition, while an example in which the core material 5 is planarized by grinding has been described in the above embodiment, the core material 5 may be planarized by other method in a mode of the present invention. For example, the core material 5 may be planarized by a polishing apparatus to which a polishing pad is mounted, or the core material 5 may be planarized by cutting by use of a cutting tool having a cutting edge formed from diamond.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A method of manufacturing a planarized core material, the method comprising:
a core material preparing step of preparing a core material formed by impregnating a glass cloth with a synthetic resin, followed by drying; and
a core material planarizing step of planarizing both sides of the core material by grinding.

2. A method of manufacturing a copper clad laminate, the method comprising:
a core material preparing step of preparing a core material formed by impregnating a glass cloth with a synthetic resin, followed by drying;
a core material planarizing step of planarizing both sides of the core material by grinding; and
a copper clad laminate forming step of disposing copper foils on both sides of the core material planarized in the core material planarizing step, and pressing the resulting assembly from the both sides with heating, to form the copper clad laminate.
